(19) United States
(12) Patent Application Publication
(10) Pub. No.: US 2015/0035767 A1
(43) Pub. Date: Feb. 5, 2015

(54) METHOD AND ELECTRONIC DEVICE FOR DISABLING A TOUCH POINT

(71) Applicant: PEGATRON CORPORATION, TAIPEI CITY (TW)

(72) Inventors: Cheng-Chou Chen, TAIPEI CITY (TW); Sung-Chen Yang, TAIPEI CITY (TW); Ta-Wei Liu, TAIPEI CITY (TW)

(21) Appl. No.: 14/311,357

(22) Filed: Jun. 23, 2014

(30) Foreign Application Priority Data
Jul. 30, 2013 (TW) 102127273

(51) Int. Cl. G06F 3/041

(52) U.S. Cl. CPC G06F 3/041
USPC 345/173

(57) ABSTRACT

A method for disabling a touch point and an electronic device adapted for this method are disclosed. The electronic device includes a touch screen and has a register table. The method includes periodically receiving touch information on the touch screen; generating touch point data corresponding to the touch information; updating the register table according to the touch point data; determining whether there exists a touch point in the register table that remains unmoved for more than a predetermined time period; and if yes, ignoring the touch point. Therefore, the method can exclude the effect to an application program due to unexpected touch behavior, so that the application program can keep operating normally.

### CROSS-REFERENCE TO RELATED APPLICATIONS

This Non-provisional application claims priority under 35 U.S.C. §119(a) on Patent Application No(s). 102127273 filed in Taiwan, Republic of China on Jul. 30, 2013, the entire contents of which are hereby incorporated by reference.

### BACKGROUND OF THE INVENTION

1. Field of Invention

The invention relates to a method and an electronic device for touch control and, in particular, to a method and an electronic device with touch control functionalities for disabling a touch point.

2. Related Art

Handheld devices have become lighter and thinner with their sizes become larger. If the width of the frame of a handheld device is insufficient, to grip the device more firmly, it is inevitable for the user to touch the device inadvertently, which causes the confusion of the user. Currently on the market there exist handheld devices with erroneous-touch prevention functions, which disable the touch function directly or implement certain special touch rules to reduce the effect of erroneous touches. In the former design, the handheld device disables the touch function directly when, for example, the handheld device enters into a conversation mode. Alternatively, when the user put the handheld device near his or her face or ear, the system can detect a specific area (that is, the area touched by the face or ear of the user) and disable the touch function of the handheld device. Under this situation, the user can grip the handheld device without invoking any touch operations. However, in other operation modes, any touch may cause the response of the system, which results in the confusion of the user. In the later design, the touch function will temporarily disabled when, for example, a finger of the user touches one point of the touch screen and remains unmoved, and the touch function is resumed when the finger starts to move. With this design, it would be inconvenient when the user needs to grip the lateral side of the handheld device for a long time since the touch function might be disabled due to the touch of the finger. In short, the erroneous-touch prevention functions mentioned above are designed for specific use scenarios. Therefore, for handheld devices there is still no erroneous-touch prevention function designed for most practical usage scenarios.

### SUMMARY OF THE INVENTION

In view of the issue in the prior art, an objective of the invention is to provide a method for disabling a touch point, which can be implemented in a handheld device. The method uses the time of the touch to determine whether it is a real touch operation or just a long touch on the touch screen due to other reasons (such as the grip of the device), therefore the unexpected touch behavior can be excluded effectively and application programs can keep operating normally.

The method of disabling a touch point according to the invention is adapted for an electronic device including a touch screen. The electronic device has a register table. The method including the steps of: periodically receiving touch information on the touch screen; generating touch point data corresponding to the touch information; updating the register table according to the touch point data; determining whether there exists a touch point in the register table that remains unmoved for more than a predetermined time period; and if yes, ignoring the touch point.

Another objective of the invention is to provide an electronic device implementing the touch point disabling method of the invention. Therefore, the electronic device can exclude the unexpected touch behavior effectively and keep operating normally.

The electronic device of the invention includes a touch screen and a processing module. The processing module is electrically connected with the touch screen and stores a register table. The processing module periodically receives touch information on the touch screen, generates touch point data corresponding to the touch information, updates the register table according to the touch point data, determines whether there exists a touch point in the register table that remains unmoved for more than a predetermined time period, and if yes, ignores the touch point.

Therefore, for example when the touch information is information having a touch point, and the touch point (or more touch points) remains unmoved for more than a predetermined time period (such as longer than the maximum time for an application program to respond to the touch operation), this touch point can be treated as an unexpected touch behavior (such as the long touch caused by gripping a handheld device) and can be ignored without passing relevant information of this touch point to relevant application program. To the application program, such touch point does not exist, thus the application program can respond to other touch operations of the user correctly, which conforms to the actual use scenario of a handheld device. The method of disabling a touch point and the electronic device implementing the same can exclude unexpected touch behaviors effectively, that is, touch point data related to this touch point is not passed to relevant application programs, so that the application programs can operate normally (such as to respond to other touch operations of the user).

The invention will become more fully understood from the detailed description and accompanying drawings, which are given for illustration only, and thus are not limitative of the present invention.

### BRIEF DESCRIPTION OF THE DRAWINGS

FIG. 1 is a schematic diagram showing a user using an electronic device.

FIG. 2 is a functional block diagram of the electronic device of FIG. 1.

FIG. 3 is a flowchart of the method of disabling a touch point according to an embodiment of the invention.

FIG. 4A and FIG. 4B are flowcharts showing the method for disabling a touch point according to an embodiment of the invention.

FIG. 5A and FIG. 5B are flowcharts showing the method for disabling a touch point according to another embodiment of the invention.

FIG. 6 is a flowchart related to the generation of the application program list in the method for disabling a touch point according to an embodiment of the invention.

### DETAILED DESCRIPTION OF THE EMBODIMENT

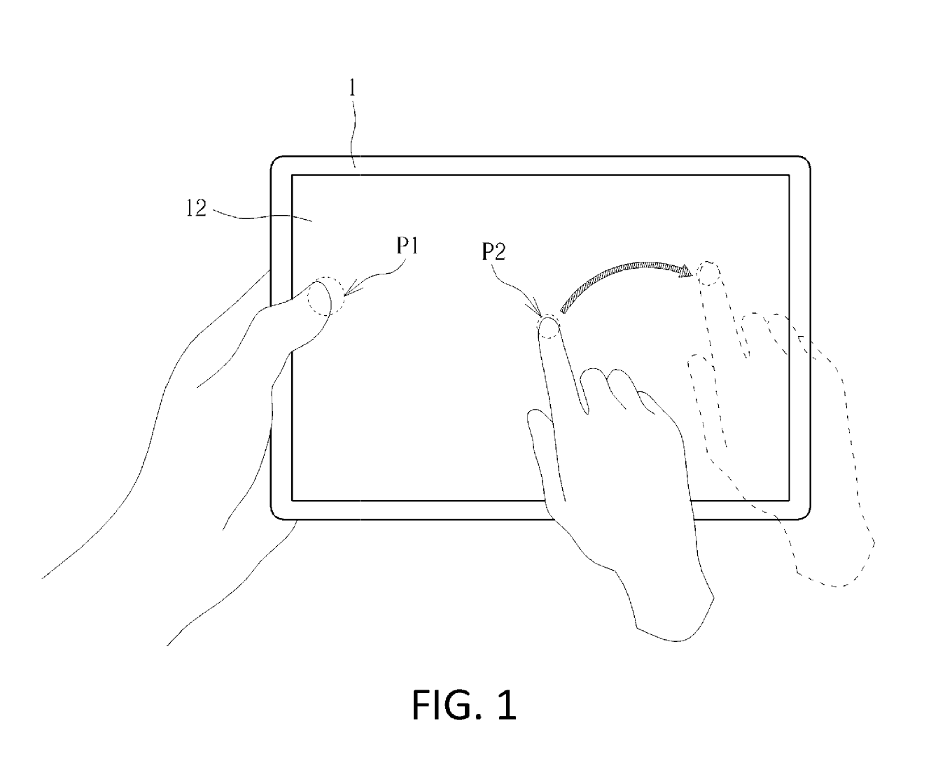

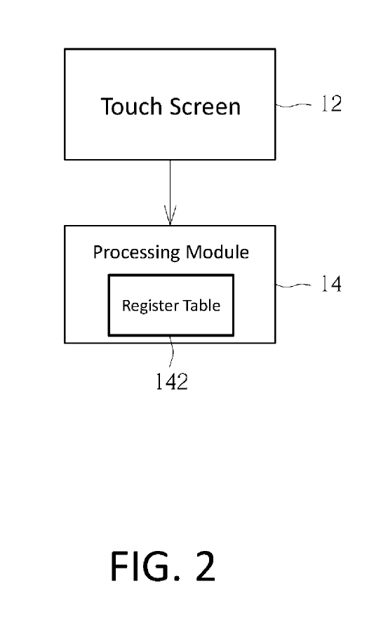

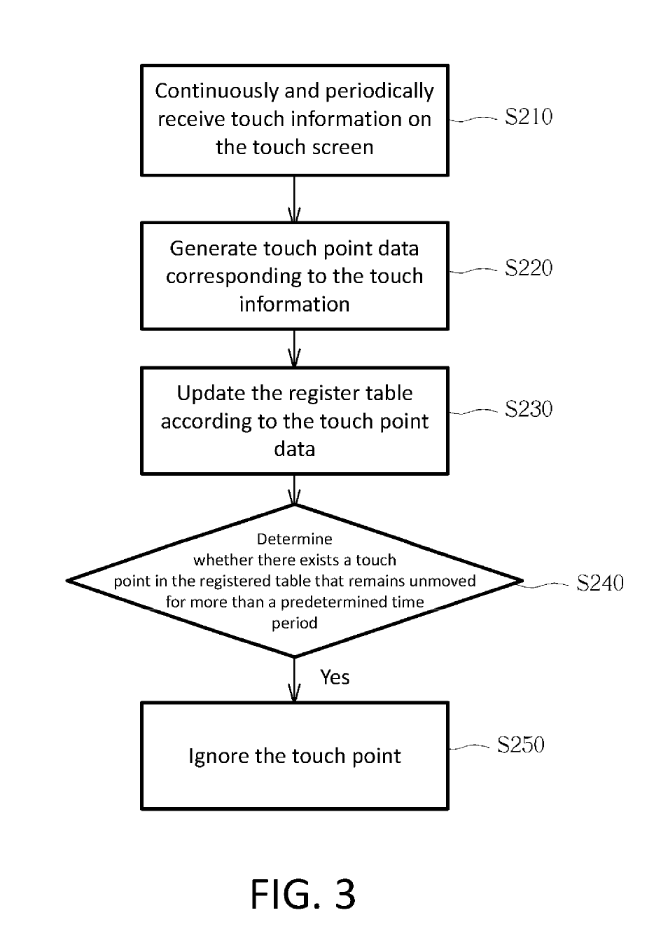

Please refer to FIG. 1 to FIG. 3. FIG. 1 is a schematic diagram showing a user using an electronic device 1. FIG. 2 is a functional block diagram of the electronic device 1. FIG. 3 is a flowchart of the method for disabling a touch point according to an embodiment of the invention. The electronic device (such as a tablet computer) includes a touch screen 12 and a processing module 14. The processing module 14 is electrically connected to the touch screen 12 and stores a register table 142. The method for disabling a touch point of the embodiment is suitable for the electronic device 1 and is implemented by the processing module 14. According to the method, touch information on the touch screen 12 is received continuously and periodically, as shown in step S210. The touch information includes information having a touch point and information having no touch point, and the receiving of the touch information continuously and periodically mentioned above is implemented by performing several receiving process within a short period of time. For example, the receiving of the touch information on the touch screen 12 continuously and periodically may be performing the touch information receiving process 60 times per second. In the present embodiment, if there are two touch points P1 and P2 on the touch screen 12, the touch information is information with the touch points P1 and P2, and the touch points P1 and P2 on the touch screen 12 can be received 60 times within 1 second. The duration of the receiving period may be determined in view the hardware driver settings, which is well known to persons having ordinary skill in the art and therefore relevant descriptions are omitted. In the present embodiment, the user grips the electronic device 1 and the thumb of the left hand touches the touch screen 12 which generates the touch point P1. It is a long touch behavior without moving. The user also performs a touch operation to the application program of the electronic device 1 by touching the touch screen 12 with the index finger of the right hand, which generates the touch point P2. The touch behavior (including time and moving path) is determined by the setting of the touch function to be executed.

According to the method, touch point data corresponding to the touch information are generated, as shown in step S220. In practice, the touch point data corresponding to each of the touch points P1 and P2 may include an identification code, a type of the touch event, and a position coordinate. The identification code (such as a positive integer) is for identifying the corresponding touch point. The type of the touch event is for identifying the touch behavior (such as a lift action, a move action or a press action) of the corresponding touch point. The position coordinate is for recording the position (such as the coordinate on the touch screen 12) of the corresponding touch point. Afterward, the touch point data are recorded or updated in the register table 142, as shown in step S230. The register table 142 is used to track the status of each touch point P1 and P2. Every time when periodically receiving touch points P1 and P2, the touch points P1 and P2 in the register table 142 can be updated correctly based on the identification code in the touch point data generated correspondingly.

According to the method, the register table 142 is used to determine whether the touch point data include a touch point that remains unmoved for more than a predetermined time period (such as the touch point P1), as shown in step S240. If yes, then this touch point (such as touch point P1) is ignored, as shown in step S250. Practically, to ignore the touch point P1 means that the touch point data related to this touch point P1 are not passed to relevant application programs. For application programs, this touch point P1 does not exist. Under this situation, the physical contact at the touch point P1 does not affect the operation of application programs (including responding to other touch operations). Moreover, the predetermined time period mentioned previously may be set or adjusted by the user. For example, it can be set to be longer than the maximum time for an application program to respond to a touch operation, so that the original touch operation related to the application program would not be interfered by the execution of the method of the present embodiment.

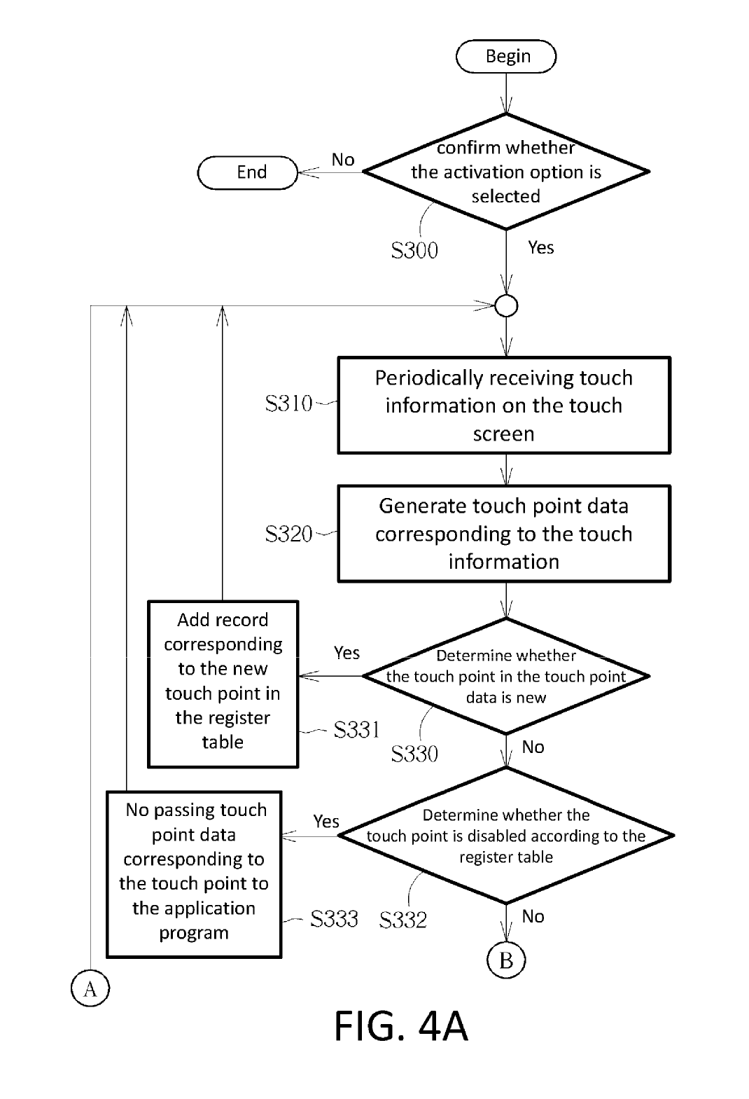

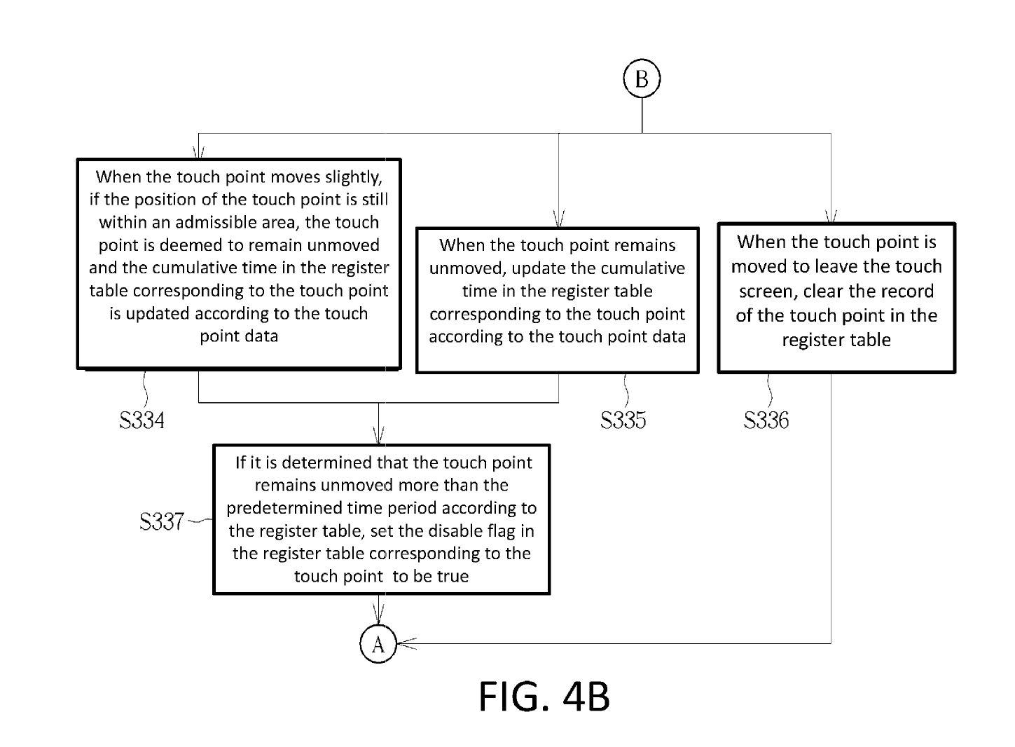

Please refer to FIGS. 4A and 4B, which are flowcharts showing the method for disabling a touch point according to an embodiment of the invention. Practically, an activation option may be provided at the operating system of the electronic device 1 for the user to decide whether to activate the method or not, as shown in step S300. First, it is confirmed whether the activation option is selected, and the method is executed if the activation option is selected. After the confirmation of the execution of the method, the touch information on the touch screen 12 of the electronic device 1 is received periodically, as shown in step S310. In the present embodiment, the touch information includes the information of the touch points P1 and P2, or includes no information of the touch points P1 and P2. Afterward, touch point data corresponding to the touch information are generated, as shown in step S320. Since the touch information on the touch screen 12 of the electronic device 1 is received periodically, an analysis corresponding to the touch point data generated every time is performed to update the register table 142. For example, the periodically receiving of the touch information may be performed multiple times per second. After the first receiving of the touch points P1 and P2 on the touch screen 12, the touch point data of the touch points P1 and P2 are recorded in the register table 142. After the second receiving of the touch points P1 and P2 on the touch screen 12 of the electronic device 1, touch point data including the information of the touch points P1 and P2 (when the touch points P1 and P2 of the touch screen 12 are touched continuously during this period) are generated again, which is used to update the register table 142.

Since the method of the embodiment is focused on the disable of the touch point which remains unmoved for a long time, practically the register table 142 may include the identification code corresponding to the touch point, the cumulative time of the touch point remains unmoved and a disable flag. The disable flag may be set to identify whether the cumulative time for the touch point to remain unmoved has exceeded a threshold to be disabled (that is, the predetermined time period mentioned previously). For example, setting the disable flag to be true means that the corresponding touch point is disabled, while setting the disable flag to be false means the corresponding touch point has not been disabled.

Next, how to update the register table 142 according to the touch point data will be explained. The register table 142 is used to determine whether the touch point in the touch point data is new, as shown in step S330. This may be realized by comparing the identification code of this touch point with the identification code recorded in the register table 142. For example, after the second receiving of the touch points P1 and P2, the identification codes corresponding to the touch points P1 and P2 are compared with the identification codes in the register table 142. Under this situation, since the identification codes of the touch points P1 and P2 are recorded in the register table 142, the determination result is no (and then proceeds to step S332). To the contrary, if the identification code in the touch point data does not exist in the register table 142, the corresponding touch point is new, that is, is received for the first time. Therefore, the register table 142 is updated to add the touch point data of the new touch point in the register table 142 (and then proceeds to step S331).

If the determination result of step S330 is yes, the record corresponding to the new touch point is added in the register table 142, as shown in step S331. The initial setting of the disable flag corresponding to the new touch point is false. If the determination result of step S330 is no, it is determined whether the touch point is disabled according to the register table 142, as shown in step S332. This can be realized by reading the setting of the disable flag in the register table 142 corresponding to this touch point. If the determination result of step S332 is yes, the touch point is already disabled and is ignored. Therefore the touch point data corresponding to the touch point are not passed to the application program, as shown in step S333. In the present embodiment, the disabled touch point is not further processed. Therefore the record in the register table 142 corresponding to this touch point can remain unchanged. However, the invention is not limited therein. Practically, whether the record in the register table 142 corresponding to the touch point needs to be changed can be determined in view of the need of practical applications.

If the determination result of step S332 is no, the register table 142 is updated according to the touch point data. Since the types of the touch events (such as a lift action, a move action or a press action) are different, different operations are performed in view of different types of the touch events. For concise purpose, the explanations below will be focused on the determination of the touch point that remains unmoved.

When the touch point moves slightly, that is, when the position of the touch point is still within an admissible area, the touch point is deemed to remain unmoved and the cumulative time in the register table 142 corresponding to the touch point is updated according to the touch point data, as shown is step S334. For example, the user may apply force at the thumb of the left hand to grip the handheld device more effectively, which causes the slight move of the touch point P1. Such slight move may be deemed as no movement which conforms to the expectation of the user. On the other hand, when the amount of the move of the touch point is larger, the touch point may be determined as undergoing a touch operation, and the touch point data corresponding to this touch point can be passed to the application program for further operations such as the move operation of the touch point P2. The admissible area may be set considering the overall behavior of ordinary users, or may be set by the user.

Moreover, when the touch point remains unmoved, the cumulative time in the register table 142 corresponding to the touch point is updated according to the touch point data, as shown in step S335. When the touch point is moved to leave the touch screen, the record of the touch point in the register table 142 is cleared, as shown in step S336. Practically, if the cumulative time of this removed touch point does not exceed the predetermined time period, the touch point data corresponding to this touch point are passed to relevant application programs for further operations, such as a single point touch control.

Moreover, after the steps S334 and S335, if it is determined that the touch point remains unmoved more than the predetermined time period according to the register table 142, the disable flag in the register table corresponding to the touch point is set to be true, that is, the touch point can be ignored, as shown in step S337. Practically, the electronic device 1 may generate a vibration simultaneously to inform the user that a touch point has been disabled. After one cycle the process can return to step S310 to execute the next cycle.

Note that the main purpose of the flowcharts shown in FIG. 4A and FIG. 4B is to describe the disable of the touch point when the time for the touch point remaining unmoved exceeds a certain threshold (the predetermined time period mentioned previously), and is not intended to limit the scope of the invention. Practically, if the ordinary touch operations (such as single touch, multi touch, slide operation or the combinations thereof) and other erroneous-touch prevention mechanism are combined into the flowchart mentioned above, the procedure would become more complex but is still within the scope of the invention which can be implemented by persons having ordinary skill in the art based on the teachings herein, therefore relevant descriptions are omitted here for concise purpose.

Furthermore, as described in the previous embodiment, whether a touch point can be passed to relevant application programs is determined by the disable flag in the register table 142. That is, whether a touch point is disabled can be determined by filtering the register table 142. Therefore, logically the register table 142 can be treated as a filter to filter out the touch points that remain unmoved for more than the predetermined time period. Since it is necessary for the method for disabling the touch point according to the embodiment to determine whether the touch point remains unmoved for more than the predetermined time period, it has the effect of delaying touch operations. Moreover, logically, although the register table 142 may be represented by the form of a table, practically it may be implemented by various kinds of data structures and is not limited to the form of a table. Moreover, the register table 142 may also be implemented by multiple tables linked to each other. The invention is not limited therein.

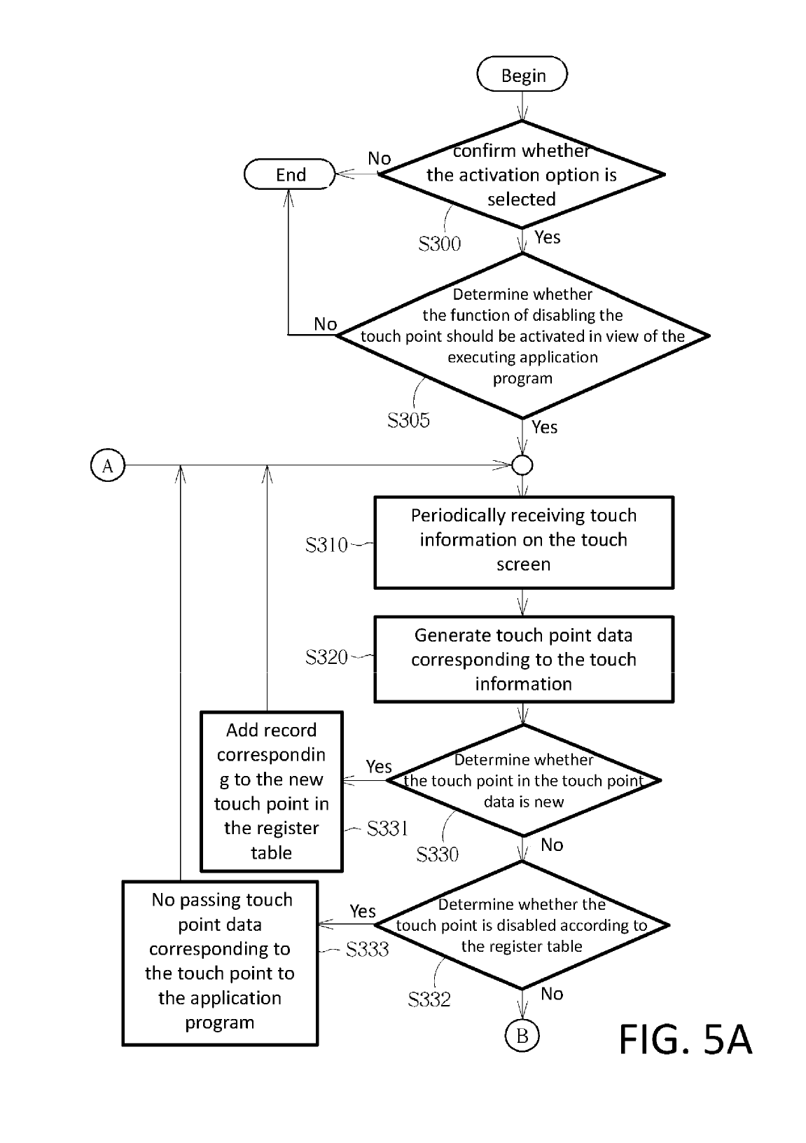

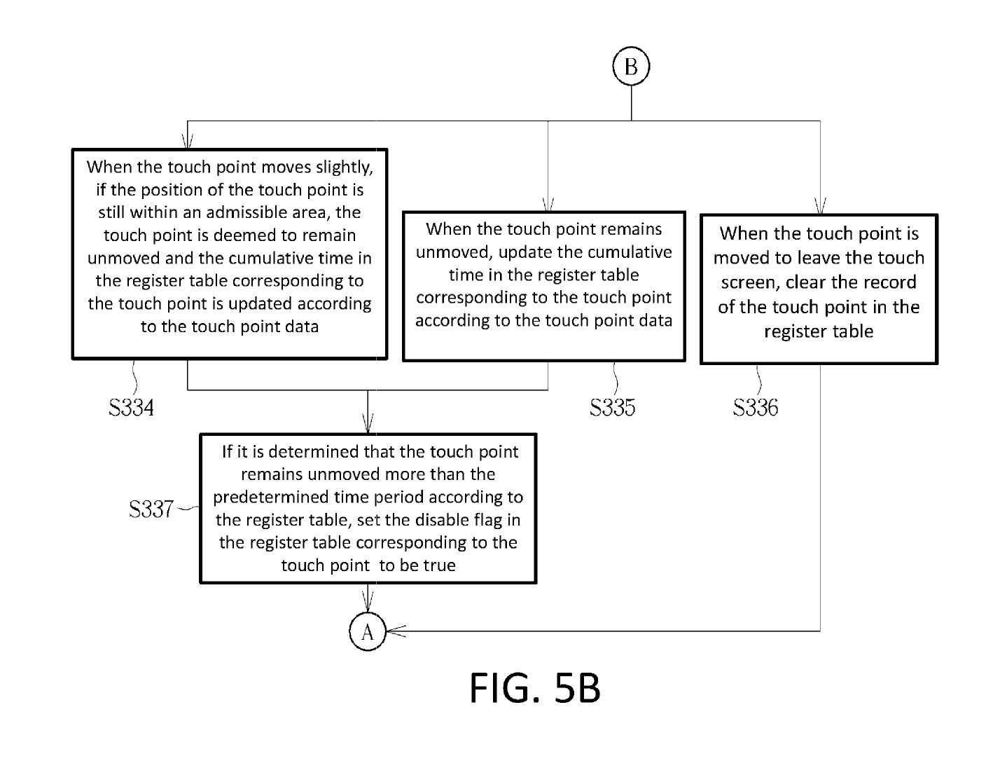

In practical applications, the touch points remain unmoved for a long time may be still meaningful for certain application programs. For example, the throttle or brake buttons of a car racing game may be pressed for a long time. Therefore, the method for disabling a touch point according to the invention may be selectively executed in view of different application programs. Please refer to FIG. 5A and FIG. 5B, which are flowcharts of the method for disabling a touch point according to another embodiment of the invention. The procedures shown in FIG. 5A and FIG. 5B are similar to those shown in FIG. 4A and FIG. 4B. The main difference is that in FIG. 5A and FIG. 5B, after the activation option is confirmed to have been selected, the procedure is executed selectively according to an application program list. As shown in step S305, whether the function of disabling the touch point should be activated in view of the executing application program is determined according to the application program list. If it is determination result of step S305 is yes, the procedure proceeds to step S310 and subsequent steps. Relevant descriptions are the same as those described previously and are omitted here for concise purpose. Basically, if all application programs installed in the electronic device 1 are included in the application program list, the activation option mentioned above can be omitted.

In practical applications, the application program list may be editable and may include name of the application programs and whether the touch point disabling function is activated or not. In the previous embodiment, when the option is selected, the touch pint disabling function of the corresponding application programs is activated, and vice versa. The application programs listed in the application program list can be added, deleted or edited by the user. Alternatively, the addition or deletion of application programs may be done by the system automatically, while the edition of the list is still reserved to the user.

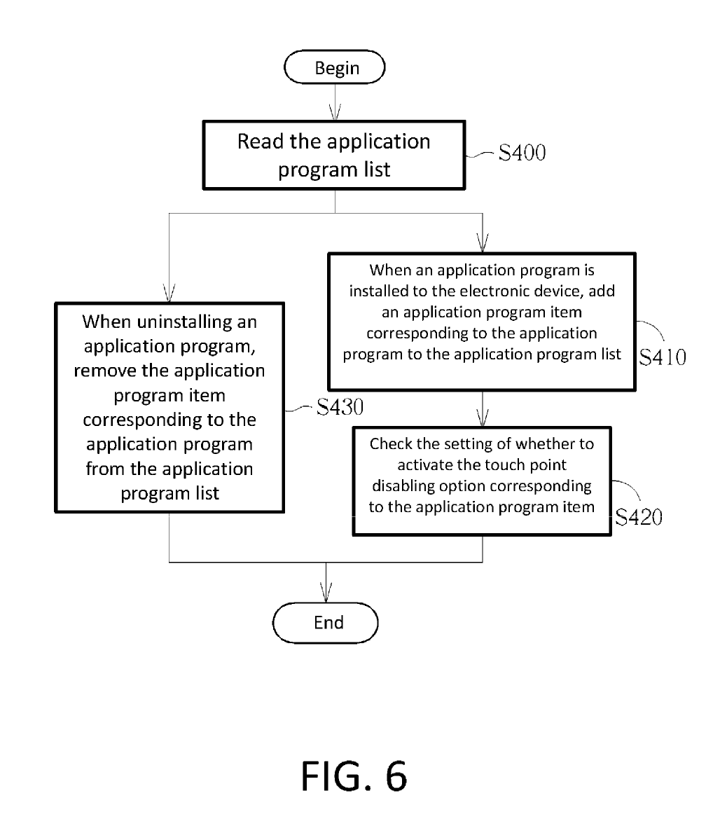

Please refer to FIG. 6, which is a flowchart showing the procedure of generating of the application program list in the method for disabling a touch point according to an embodiment of the invention. The procedure is triggered when installing or uninstalling an application program. As shown in step S400, the application program list is read. If no application program list exists (such as first installing the application program), the application program list is established. Then, when an application program is installed to the electronic device 1, an application program item corresponding to the application program is added to the application program list, as shown in step S410. Next, it is checked whether to activate the touch point disabling option corresponding to the application program item. In practical applications, in step S420, the item can be set to be selected automatically, or a prompt to configure the setting can be provided to the user. Similarly, when uninstalling an application program, the application program item corresponding to the application program can be removed from the application program list, as shown in step S430. Note that in practical applications, all installed application programs are retrieved to establish corresponding application program items when establishing the application program list for the first time.

To sum up, the touch point disabling method and the device implementing this method according to the invention uses the duration of the touch point to prevent an application program from being affected by an unexpected touch behavior. Simply speaking, when a touch point (or more touch points) remains unmoved for more than a predetermined time period (such as longer than the maximum time for an application program to respond to the touch operation), this touch point can be treated as an unexpected touch behavior (such as the long touch caused by gripping the handheld device) and can be ignored without passing relevant information of this touch point to relevant application program. To the application program, such touch point does not exist, thus the application program can respond to other touch operations of the user correctly, which conforms to the actual use scenario of the handheld device. Therefore, the invention can solve the issue in the prior art that cannot distinguish an unexpected touch behavior and a normal touch behavior, and can provide a user a more convenient touch control environment.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for disabling a touch point adapted for an electronic device including a touch screen, the electronic device having a register table, the method comprising the steps of:
periodically receiving touch information on the touch screen;
generating touch point data corresponding to the touch information;
updating the register table according to the touch point data;
determining whether there exists a touch point in the register table that remains unmoved for more than a predetermined time period; and
if yes, ignoring the touch point.

2. The method according to claim 1, wherein the touch point data comprise an identification code, a type of the touch event and a position coordinate corresponding to the touch point.

3. The method according to claim 1, wherein the register table comprises an identification code, a cumulative time for the touch point to remain unmoved and a disable flag.

4. The method according to claim 1, wherein in the determining step, the touch point is deemed to remain unmoved if the position of the touch point varies within an admissible area.

5. The method according to claim 1, wherein the updating step further comprises the step of:
clearing the record of the touch point in the register table when the touch point is removed from the touch screen.

6. The method according to claim 1, wherein the ignoring step further comprises the step of:
generating a vibration on the electronic device.

7. The method according to claim 1, wherein the predetermined time period is longer than the maximum time for an application program to respond to a touch operation.

8. The method according to claim 1, wherein the method is executed when an activation option is selected.

9. The method according to claim 1, wherein the method is selectively executed according to an application program list.

10. The method according to claim 9, further comprising the steps of:
when a first application program is installed to the electronic device, adding an application program item corresponding to the first application program to the application program list; and
when a second application program is uninstalled from the electronic device, removing the application program item corresponding to the second application program from the application program list.

11. An electronic device, comprising:
a touch screen;
a processing module electrically connected with the touch screen, the processing module storing a register table, the processing module periodically receiving touch information on the touch screen, generating touch point data corresponding to the touch information, and updating the register table according to the touch point data, the processing module determining whether there exists a touch point in the register table that remains unmoved for more than a predetermined time period, and if yes, ignoring the touch point.
